(19) United States
(12) Patent Application Publication
(10) Pub. No.: US 2025/0287065 A1
(43) Pub. Date: Sep. 11, 2025

(54) IMAGE PROCESSING METHOD, APPARATUS, ELECTRONIC DEVICE, AND COMPUTER-READABLE STORAGE MEDIUM

(71) Applicant: GUANGDONG OPPO MOBILE TELECOMMUNICATIONS CORP., LTD., Dongguan (CN)

(72) Inventors: Xinyi GAO, Dongguan (CN); Wei WANG, Dongguan (CN)

(73) Assignee: GUANGDONG OPPO MOBILE TELECOMMUNICATIONS CORP., LTD., Dongguan (CN)

(21) Appl. No.: 19/217,894

(22) Filed: May 23, 2025

Related U.S. Application Data
(63) Continuation of application No. PCT/CN2023/117521, filed on Sep. 7, 2023.

(30) Foreign Application Priority Data
Nov. 24, 2022 (CN) 202211485281.5

(51) Int. Cl. H04N 21/431; H04N 21/472

(52) U.S. Cl. CPC H04N 21/4318; H04N 21/47217

(57) ABSTRACT

An image processing method is performed by an electronic device. The method includes: receiving a first preset operation configured to mark at least one of a plurality of video frames in a case that the plurality of video frames are displayed on a screen of the electronic device; after receiving the first preset operation, determining a target video frame corresponding to the first preset operation; setting a specified mark for the target video frame.

### CROSS REFERENCE TO RELATED APPLICATIONS

The present application is a continuation application of the international patent application No. PCT/CN2023/117521, filed on Sep. 7, 2023, which claims the priority of the Chinese patent application No. 202211485281.5, filed on Nov. 24, 2022, contents of which are incorporated herein by reference in their entireties.

### TECHNICAL FIELD

Embodiments of the present disclosure relate to the technical field of mobile terminals, and more specifically, to an image processing method, an apparatus, an electronic device, and a computer-readable storage medium.

### BACKGROUND

As technology develops, electronic devices are increasingly widely used and provide more functions. The electronic devices have become one of necessities in daily life. For example, a user may use an electronic device to capture or play a video and edit the video.

### SUMMARY

The present disclosure provides an image processing method, an apparatus, an electronic device, and a computer-readable storage medium.

In a first aspect, the present disclosure provides an image processing method, performed by an electronic device. The method includes: receiving a first preset operation configured to mark at least one of a plurality of video frames in a case that the plurality of video frames are displayed on a screen of the electronic device; after receiving the first preset operation, determining a target video frame corresponding to the first preset operation; setting a specified mark for the target video frame.

In a second aspect, the present disclosure provides an image processing method, performed by an electronic device. The method includes: displaying, in a specified interface, a preset progress bar corresponding to a video file; displaying, at a target position corresponding to the target video frame on the preset progress bar, a specified mark of a target video frame, wherein the specified mark is a marker set for the target video frame based on a first preset operation when a plurality of video frames are displayed on a screen of the electronic device; performing, based on a first target operation performed on the specified mark, a second target operation corresponding to the first target operation on a video frame corresponding to the specified mark.

In a third aspect, the present disclosure provides an image processing apparatus, configured in an electronic device. The apparatus includes: a first display unit, configured to receive a first preset operation configured to mark at least one of a plurality of video frames in a case that the plurality of video frames are displayed on a screen of the electronic device; a determining unit, configured to receive the first preset operation configured to mark the at least one video frame and determine a target video frame corresponding to the first preset operation; and a marking unit, configured to set a specified mark for the target video frame.

In a fourth aspect, the present disclosure provides an image processing apparatus, configured in an electronic device. The apparatus includes: a second display unit, configured to: display a preset progress bar corresponding to a video file within a specified interface, display a specified mark for a target video frame at a target position corresponding to the target video frame on the preset progress bar, wherein the specified mark is a mark set for the target video frame based on a first preset operation when a plurality of video frames are displayed on a screen of the electronic device; and an operation unit, configured to perform, based on a first target operation performed on the specified mark, a second target operation corresponding to the first target operation on the video frame corresponding to the specified mark.

In a fifth aspect, the present disclosure provides an electronic device including: one or more processors; a memory; and one or more applications, being stored in the memory and configured to be executed by the one or more processors to perform the method in the above.

In a sixth aspect, the present disclosure provides a computer-readable medium, having program codes stored therein. The program codes are configured to be executed by a processor to cause the processor to perform the method in the above.

### BRIEF DESCRIPTION OF THE DRAWINGS

In order to more clearly illustrate technical solutions in embodiments of the present disclosure, accompanying drawings used in the embodiments will be briefly introduced below. Obviously, the accompanying drawings in the following description show only some of the embodiments of the present disclosure, and any ordinary skilled person in the art may obtain other accompanying drawings based on these drawings without creative work.

FIG. 1 is a schematic view of a foldable terminal being in a folded state according to an embodiment of the present disclosure.

FIG. 2 is a schematic view of a foldable terminal being in an unfolded state according to an embodiment of the present disclosure.

FIG. 3 is a flow chart of an image processing method according to an embodiment of the present disclosure.

FIG. 4 is a schematic view of a video capturing interface according to an embodiment of the present disclosure.

FIG. 5 is a schematic view of performing an operation on a preset control according to an embodiment of the present disclosure.

FIG. 6 is a schematic view of a first progress bar according to an embodiment of the present disclosure.

FIG. 7 is a flow chart of the image processing method according to another embodiment of the present disclosure.

FIG. 8 is a schematic view of a video playing interface according to an embodiment of the present disclosure.

FIG. 9 is a schematic view of a user performing operations on a specified mark in the video playing interface according to an embodiment of the present disclosure.

FIG. 10 is a schematic view of a video editing interface according to an embodiment of the present disclosure.

FIG. 11 is a flow chart of performing a first editing operation according to an embodiment of the present disclosure.

FIG. 12 is a schematic view of performing an operation to enter an editing mode for a specified mark according to an embodiment of the present disclosure.

FIG. 13 is a schematic view of a preset selection box according to an embodiment of the present disclosure.

FIG. 14 is a schematic view of a first box and a second box according to an embodiment of the present disclosure.

FIG. 15 is a schematic view of performing a sliding operation on the first box of the preset selection box according to an embodiment of the present disclosure.

FIG. 16 is a schematic view of performing a sliding operation on the second box of the preset selection box according to an embodiment of the present disclosure.

FIG. 17 is a flow chart of performing a second editing operation according to an embodiment of the present disclosure.

FIG. 18 is a schematic view of performing a dragging operation on a specified mark under the editing mode for the specified mark according to an embodiment of the present disclosure.

FIG. 19 is a schematic view of the dragging operation, which is on the specified mark under the editing mode for the specified mark, being completed according to an embodiment of the present disclosure.

FIG. 20 is a flow chart of the image processing method according to still another embodiment of the present disclosure.

FIG. 21 is a schematic view of performing a dragging operation on a specified mark under an editing mode of non-specified marks according to an embodiment of the present disclosure.

FIG. 22 is a schematic view of performing a dragging operation on a specified mark under an editing mode of non-specified marks according to another embodiment of the present disclosure.

FIG. 23 is a schematic view of the dragging operation, which is on the specified mark under the editing mode of non-specified marks, being completed according to an embodiment of the present disclosure.

FIG. 24 is a schematic view of performing a save operation according to an embodiment of the present disclosure.

FIG. 25 is a schematic view of a save selection interface according to an embodiment of the present disclosure.

FIG. 26 is a flow chart of the image processing method according to still another embodiment of the present disclosure.

FIG. 27 is a structural schematic diagram of an image processing apparatus according to an embodiment of the present disclosure.

FIG. 28 is a structural schematic diagram of the image processing apparatus according to another embodiment of the present disclosure.

FIG. 29 is a structural schematic diagram of an electronic device according to an embodiment of the present disclosure.

FIG. 30 is a structural schematic diagram of a computer-readable storage medium according to an embodiment of the present disclosure.

FIG. 31 is a structural schematic diagram of a computer product according to an embodiment of the present disclosure.

### DETAILED DESCRIPTIONS

The technical solutions in the embodiments of the present disclosure will be described clearly and completely in the following by referring to the accompanying drawings in the embodiments of the present disclosure. Obviously, the described embodiments are only a part of, not all of, the embodiments of the present disclosure. All other embodiments, which are obtained by any ordinary skilled person in the art based on the embodiments in the present disclosure without making creative work, shall fall within the scope of the present disclosure.

It should be noted that similar symbols and letters denote similar items in the following drawings, and therefore, once an item is defined in one drawing, the item does not need to be further defined and explained in subsequent drawings. Furthermore, in the description of the present disclosure, terms “first”, “second” and the like are used only for distinguishing features and shall not be interpreted as indicating or implying relative importance.

As technology develops, electronic devices are increasingly widely used and provide more functions. The electronic devices have become one of necessities in daily life. An electronic device may usually be arranged with a screen, which may be a touch screen and configured to display contents and receive touch gestures input by a user. According to materials and structures of the screen, the electronic device may be a single-side screen terminal, a double-side screen terminal, and a foldable terminal. The screen of the foldable terminal may be a flexible display screen, and switching of the screen from an unfolded state to a folded state may be achieved by arranging hardware structure such as a hinge. In the related art, the electronic device having a foldable screen may be in a folded state or an unfolded state. When in the unfolded state, the foldable screen may have a plurality of displaying regions and display contents on the plurality of displaying regions. In this case, the entire touch screen has a larger size.

In addition, with the development of technology, in order to enable the user to experience a larger operation area and a larger displaying area when the screen is split, the electronic device may be a terminal having a foldable screen. In this way, when the electronic device is unfolded, a displaying area of the entire screen is larger than a displaying area of a single-side screen or dual screens. The number of suspending windows that can be displayed may be increased as the screen is enlarged.

The present disclosure provides an image processing method, performed by an electronic device. The method may include: receiving a first preset operation configured to mark one of a plurality of video frame in a case that the plurality of video frames are displayed on a screen of the electronic device; determining a target video frame corresponding to the first preset operation after receiving the first preset operation; and setting a specified mark for the target video frame.

In some embodiments, the operation of setting the specified mark for the target video frame may include: determining a timestamp of the target video frame corresponding to the specified mark; determining a target position corresponding to the timestamp in a first progress bar corresponding to the plurality of video frames; in a process of displaying the plurality of video frames on the screen, displaying the first progress bar on the screen and displaying the specified mark at the target position of the first progress bar.

In some embodiments, displaying the plurality of video frames on the screen of the electronic device may include recording a video on the electronic device. After setting the specified mark for the target video frame, the method further may include: saving the plurality of video frames as a video file, marking the target video frame in the video file with the specified mark.

In some embodiments, after setting the specified mark for the target video frame, the method further may include: displaying a second progress bar in a video editing interface during editing the video file; displaying the specified mark of the target video frame at the target position corresponding to the target video frame on the second progress bar; when detecting a touch operation performed on the specified mark, displaying a preset selection box at the target position corresponding to the specified mark on the second progress bar; determining a region range boxed by a user on the second progress bar based on the preset selection box; and applying all video frames corresponding to the region range on the second progress bar as a video segment corresponding to the specified mark.

In some embodiments, the preset selection box may include a first box and a second box. The operation of determining the region range selected by the user based on the preset selection box on the second progress bar may include: changing a position of a specified box on the second progress bar based on a detected sliding operation performed on the specified box; and when the sliding operation being completed, applying a region between the first box and the second box as the region range. The specified box is at least one of the first box and the second box.

In some embodiments, the method further may include: determining a specified position, which is specified by the specified box on the second progress bar and is specified between a touch operation start time point and a touch operation end time point of the sliding operation; displaying a video frame corresponding to the specified position on the second progress bar on the video editing interface.

In some embodiments, the first box and the second box are respectively located on a left side and a right side of a centerline region of the preset box. The centerline region is located at the target position of the second progress bar. The specified box is the first box. The operation of displaying the video frame corresponding to the specified position on the second progress bar on the video editing interface, may include: displaying, in a first region of the video editing interface, a video frame corresponding to the specified position specified by the first box on the second progress bar; displaying the target video frame in a second region of the video editing interface. The first region is located closer to a start position of the second progress bar than the second region is.

In some embodiments, the first box and the second box are respectively located on the left side and the right side of the centerline region of the preset box. The centerline region is located at a target position of the second progress bar. The specified box is the second box. The operating of displaying the video frame corresponding to the specified position on the second progress bar in the video editing interface, may include: displaying the target video frame in the first region of the video editing interface; displaying, in the second region of the video editing interface, the video frame corresponding to the specified position on the second progress bar specified by the second box. The first region is located closer to the start position of the second progress bar than the second region is.

In some embodiments, after saving the plurality of video frames as the video file, the method further may include: displaying the second progress bar in the video editing interface during editing the video file; displaying the specified mark of the target video frame at the target position corresponding to the target video frame on the second progress bar; detecting a dragging operation performed on the specified mark; and determining, based on the dragging operation, an end position of the specified mark on the second progress bar when the dragging operation being completed; applying a video frame corresponding to the end position as the video frame corresponding to the specified mark.

In some embodiments, after saving the plurality of video frames as the video file, the method further may include: displaying the second progress bar in the video editing interface during editing the video file; displaying the specified mark of the target video frame at the target position corresponding to the target video frame on the second progress bar; detecting the dragging operation performed on the specified mark; and changing, based on the dragging operation, a position of the video frame corresponding to the specified mark on the second progress bar.

In some embodiments, the operation of receiving the first preset operation configured to mark the video frame in the case of the plurality of video frames being displayed on the screen of the electronic device may include: during the electronic device performing video recording, displaying the plurality of video frames, which are captured during the video recording, on the screen of the electronic device; receiving the first preset operation configured to mark the video frame.

The present disclosure provides an image processing method, performed by the electronic device, the method may include: displaying a preset progress bar corresponding to the video file in a specified interface; displaying the specified mark of the target video frame at the target position corresponding to the target video frame on the preset progress bar; performing, based on a first target operation performed on the specified mark, a second target operation corresponding to the first target operation on the video frame corresponding to the specified mark. The specified mark is a marker set for the target video frame based on the first preset operation when the plurality of video frames are being displayed on the screen of the electronic device.

In some embodiments, the specified interface may include the video editing interface. The preset progress bar may include the second progress bar. The operation of performing, based on the first target operation performed on the specified mark, the second target operation corresponding to the first target operation on the video frame corresponding to the specified mark, may include: performing, based on a second preset operation performed on the specified mark, an editing operation corresponding to the second preset operation on the video frame corresponding to the specified mark.

In some embodiments, the operation of performing, based on the second preset operation performed on the specified mark, the editing operation corresponding to the second preset operation on the video frame corresponding to the specified mark, may include: detecting a touch operation performed on the specified mark; displaying the preset selection box at the target position corresponding to the specified mark on the second progress bar; determining the region range of the second progress bar boxed by the user using the preset selection box; applying all video frames corresponding to the region range on the second progress bar as the video segment corresponding to the specified mark.

In some embodiments, the operation of performing, based on the second preset operation performed on the specified mark, the editing operation corresponding to the second preset operation on the video frame corresponding to the specified mark may include: determining, based on the dragging operation performed on the specified mark, the end position of the specified mark on the second progress bar when the dragging operation being completed; applying the video frame corresponding to the end position as the video frame corresponding to the specified mark.

In some embodiments, the operation of performing, based on the second preset operation performed on the specified mark, the editing operation corresponding to the second preset operation on the video frame corresponding to the specified mark may include: changing, based on the dragging operation performed on the specified mark, a position of the video frame corresponding to the specified mark in the second progress bar.

In some embodiments, a plurality of specified marks are provided. After performing, based on the second preset operation performed on the specified mark, the editing operation corresponding to the second preset operation on the video frame corresponding to the specified mark, the method further may include: combining and saving all video frames corresponding to all of the plurality of specified marks as a first video file.

In some embodiments, after performing, based on the second preset operation performed on the specified mark, the editing operation corresponding to the second preset operation on the video frame corresponding to the specified mark, the method further may include: saving the video frame corresponding to each of the plurality of specified marks as one video file.

In some embodiments, after performing, based on the second preset operation performed on the specified mark, the editing operation corresponding to the second preset operation on the video frame corresponding to the specified mark, the method further may include: in the case that one video frame corresponds to the specified mark, saving the video frame corresponding to the specified mark as a target picture.

In some embodiments, the specified interface may include a video playing interface. The preset progress bar may include a playing progress bar. The operation of performing, based on the first target operation performed on the specified mark, the second target operation corresponding to the first target operation on the video frame corresponding to the specified mark, may include: displaying, based on the first target operation performed on the specified mark, the video frame corresponding to the specified mark within a video displaying region of the video playing interface; and adjusting a playing progress of the playing progress bar to the position corresponding to the specified mark on the playing progress bar.

Application scenarios in which embodiments of the present disclosure may be applied will be described in the following.

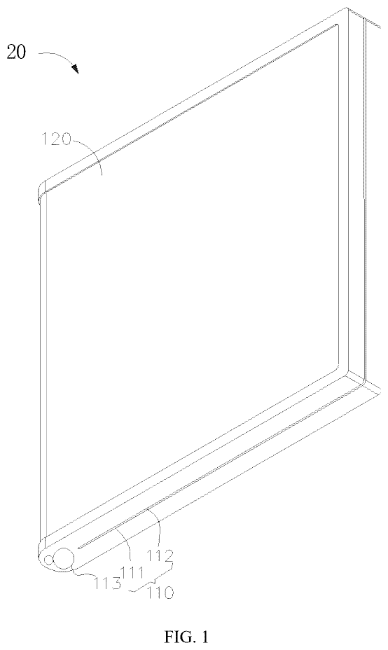

As shown in FIG. 1, the electronic device 20 is a terminal having a foldable screen and may include a foldable housing assembly 110, a flexible display screen 120, and electronic components (not shown in the drawings). The electronic components may be arranged inside the foldable housing assembly 110. The flexible display screen 120 may be laid on the foldable housing assembly 110. The foldable housing assembly 110 may be configured to carry the flexible display screen 120 and protect the electronic components. The electronic components may include, but not limited to, a central processing unit, a memory, a camera, a receiver, a fingerprint module, and so on. Specific electronic components may not be limited herein.

The foldable housing assembly 110 may include a first housing 111, a second housing 112, and a pivot mechanism 113. The first housing 111 and the second housing 112 are connected to two sides of the pivot mechanism 113, respectively. The second housing 112 may be folded or unfolded relative to the first housing 111 via the pivot mechanism 113, enabling the foldable housing assembly 110 to drive the flexible display screen 120 to be folded or unfolded. When the foldable housing assembly 110 and the flexible display screen 120 are folded, a size of the electronic device 100 may be relatively small, and the electronic device 100 may be easily stored and carried. When the foldable housing assembly 110 and the flexible display screen 120 are unfolded, the size of the electronic device 100 may be relatively, and the electronic device 100 display information conveniently.

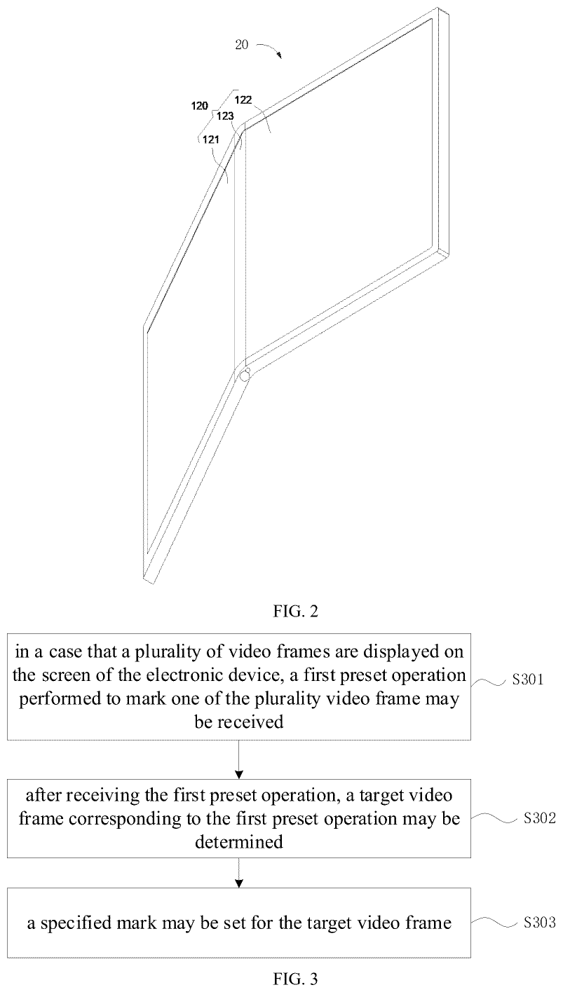

As shown in FIG. 2, in the present embodiment, the flexible display screen 120 may include a first display portion 121 connected to the first housing 111, a second display portion 122 connected to the second housing 112, and a foldable display portion 123 connected to both the first display portion 121 and the second display portion 122. The first display portion 121, the second display portion 122, and the foldable display portion 123 may correspondingly form a plurality of displaying regions (such as forming two, three, four, . . . . N displaying regions). The first display portion 121 and the second display portion 122 may be folded or unfolded with respect to each other as the first housing 111 and the second housing 112 are folded or unfolded. The foldable display portion 123 may be bent or flattened as the first display portion 121 and the second display portion 122 are folded or unfolded. In some embodiments, the first display portion 121, the second display portion 122, and the foldable display portion 123 may be configured as a one-piece structure, such that the flexible display screen 120 may be a one-piece flexible display screen. In some embodiments, the foldable display portion 123 may be a flexible portion that is bendable, and the first display portion 121 and the second display portion 122 may be non-flexible portions. The first display portion 121 and second display portion 122 may be folded or unfolded relative to each other via the foldable display portion 123. In the present embodiment, when the first housing 111 and the second housing 112 are folded to each other, the first display portion 121 and the second display portion 122 face away from each other, such that the screen of the electronic device 100 may be folded outwardly, and the user may observe displayed contents of the flexible display screen 120 in the folded state. The electronic device 100 may be used more conveniently. In some embodiments, when the first housing 111 and the second housing 112 are folded to each other, the first display portion 121 and the second display portion 122 approach to each other, such that the screen of the electronic device 100 is folded inwardly, and the flexible display screen 120 is prevented from being scratched and damaged.

To be understood that the first display portion 121, the second display portion 122, and the foldable display portion 123 are named for description convenience only, and do not form structural limitation to the flexible display screen 120. In practice, no obvious boundaries may be formed between the first display portion 121, the second display portion 122, and the foldable display portion 123. Alternatively, the flexible display screen 120 may be divided in other manners. For example, the flexible display screen 120 may include a first display portion 121 and a second display portion 122 connected to the first display portion 121, and the first display portion 121 and the second display portion 122 may be rotatable relative to each other to be folded or unfolded relative to each other.

To be noted that a specific configuration of the electronic device herein may be the terminal having the foldable screen or the flexible screen as described above, or may be a single-side-screen mobile phone as described above, which will not be limited herein.

Currently, when the user is using the electronic device, a major demand may be using the electronic device to play a video, run a game application, or read contents of interest. Of course, the user may use the electronic device to record a video. In the art, when playing a video, it may be difficult for the user to mark a video frame of interest so as to quickly locate a position of the video frame of interest when editing the video in the future.

Therefore, in order to solve the above technical problem, in the present disclosure, the video frame of interest may be easily and quickly marked during the video being played.

As shown in FIG. 3, FIG. 3 is a flow chart of an image processing method according to an embodiment of the present disclosure. The method may be performed by the above-described electronic device, specifically, the method may include operations S301 to S303.

In an operation S301, in a case that a plurality of video frames are displayed on the screen of the electronic device, a first preset operation performed to mark one of the plurality video frame may be received.

To be noted that a video played on the screen of the electronic device may be a video file played by the user via a video playing software, a game image run by the user via a game software, or a video recorded during a video recording stage, which will not be limited herein.

In the case that the plurality of video frames are displayed on the screen of the electronic device, the electronic device may detect a first preset operation. The first preset operation may be configured to mark the video. The first preset operation may be a single click, continuous clicks, a long press operation, or a sliding operation having a certain sliding trajectory, which will not be limited herein.

To be noted that the user may input the first preset operation through the screen of the electronic device. Exemplarily, in the case that the plurality of video frames are displayed on the screen of the electronic device, a preset component may be displayed on the screen of the electronic device, and the user may input the first preset operation by performing an operation on the preset component.

Exemplarily, the preset component and the plurality of video frames may be displayed within a same interface. In a case, the interface in which the plurality of video frames are displayed on the screen may be a video playing interface, and the preset component may be displayed in the video playing interface. For example, the preset component may be a touch component in the video playing interface. The touch component may be displayed suspendingly or non-suspendingly. In an embodiment, the preset component may be a suspending ball and displayed in the video playing interface. Of course, the preset component may alternatively be displayed in a displaying region out of the video playing interface. For example, the screen of the electronic device may have at least two displaying regions, the at least two displaying regions may include a first displaying region and a second displaying region. The video playing interface may be displayed in the first displaying region, and the preset component may be displayed in the second displaying region. For example, for the foldable screen in the above, the first displaying region may be disposed in the first display portion, and the second displaying region may be disposed in the second display portion.

In the present embodiment, a user, during recording a video, may wish to mark the video while recording and may not need to mark the video during reviewing the video after finishing the recording. Therefore, the plurality of video frames may be a plurality of video frames captured in the process of recording the video. In an example, in the case of displaying the plurality of video frames on the screen of the electronic device, displaying the preset component on the screen of the electronic device may refer to displaying, during the electronic device recording the video, the preset component and the plurality of video frames captured during the video recording on the screen of the electronic device. The video recording may be a process in which the electronic device captures the video via a camera or a process in which the screen is recorded via a screen recording program, which will not be limited herein.

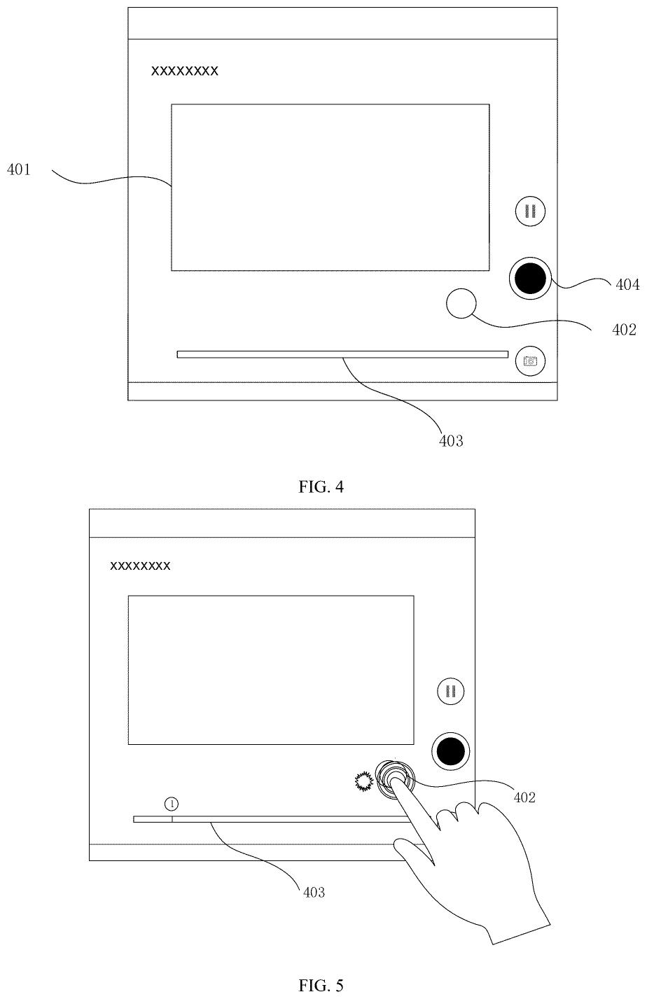

In an example, in the process of performing the video recording by the electronic device, a video recording interface may be displayed on the screen of the electronic device. As shown in FIG. 4, the video recording interface may include a video displaying region 401, the preset component 402, and a first progress bar 403. In the process of the video recording, the plurality of video frames captured by the electronic device may be displayed sequentially in the video displaying region 401. The first progress bar 403 may be configured to indicate a progress of the video recording. Each position on the first progress bar 403 corresponds to a capturing time point of one video frame. Exemplarily, the capturing time point of the video frame may be used as a timestamp of the video frame. The timestamp of each of the plurality of video frame has a respective position on the first progress bar 403.

In an embodiment, the video recording interface may further include a video recording operation component, such as a shutter button 404 shown in FIG. 4. The user may perform an operation on the shutter button 404 to control the video recording to be started, paused, ended, and resumed. Usually, when the user uses the electronic device to perform the video recording, a hand of the user may hold the electronic device and may be located at a position near the shutter button 404, such that the shutter button 404 may be operated quickly. Exemplarily, the preset component 402 may be set to be located close to the shutter button 404, but a distance between the preset component 402 and the shutter button 404 may be greater than a predetermined value, so as prevent interference with each other. Of course, the preset component 402 may alternatively be arranged at other positions, which will not be limited herein.

In an operation S302, after receiving the first preset operation, a target video frame corresponding to the first preset operation may be determined.

The operation S302 will be illustrated by taking the preset component as an example. In an example, the first preset operation may be a preset touch operation performed on the preset component. When the preset component is detected as being touched, it may be determined whether the received touch operation performed on the preset component is the preset touch operation. When the received touch operation performed on the preset component is the preset touch operation, the target video frame corresponding to the touch operation may be determined. The preset touch operation may be a single-click operation, a continuous-click operation, or a long-press operation. The continuous-click operation may be double clicks or a plurality of clicks, and the number of the plurality of clicks may be greater than 2. In the present embodiment, the preset touch operation may be the single-click operation. Therefore, when the preset component is detected as receiving the single-click operation, a target video frame corresponding to the single-click operation may be determined.

To be noted that, for determining the target video frame corresponding to the first preset operation, after receiving the first preset operation, for example, after detecting that the preset component is touched, a video frame displayed on the screen at the time of detecting the preset touch operation performed on the preset component may be determined as the target video frame. Exemplarily, when the preset component is detected as being touched, an operation time point of the touch operation may be determined, a video frame corresponding to a playing time point matching the operation time point may be searched based on a playing time point of each of the plurality of video frames on the screen. In this way, the video frame, which is displayed on the screen at the time of the touch operation performed on the preset component being detected, may be found, and the found video frame may be determined as the target video frame. That is, as shown in FIG. 5, during displaying the plurality of video frames on the screen, when the user sees a video frame of interest, and the user may input the touch operation via the preset component, such as by single-clicking the preset component, the electronic device may correspond the touch operation on the preset component to the video frame displayed on the screen of the electronic device, so as to obtain the video frame, which is displayed on the screen at the time when the user clicks on the preset component, i.e., the target video frame.

In an operation S303, a specified mark may be set for the target video frame.

After determining the target video frame corresponding to the first preset operation, the specified mark may be set for the target video frame. In some embodiments, the specified mark may be embedded in a displayed content of the video frame. For example, a specified content, which may be similar to a watermark of the video frame, may be added to the display content of the video frame, and the added specified content serves as the specified mark. Of course, the specified mark may alternatively serve as a label of the video frame. That is, when the video frame is saved, the specified mark of the target video frame may be saved together, as shown in Table 1 below.

TABLE 1

| Video frame | timestamp | Specified mar |
|---|---|---|
| frame 1 | T1 | none |
| frame 2 | T2 | Mark 1 |
| frame 3 | T3 | none |
| . . . | . . . | . . . |
| frame n | Tn | none |

In other words, the specified mark of the target video frame may be saved as a label corresponding to the video frame. In this way, when a plurality of video frames are saved, for example, after the video recording is completed to obtain the video file, specified marks set for target video frames of the video file may be saved as well, and mapping between each video frame of the video file and the corresponding specified mark may be recorded. Therefore, regardless of playing or editing the video file subsequently, after parsing the video file to obtain the video frames, the video frames of the video file that are set with the specified marks can be clearly known.

Exemplarily, each video frame corresponds to one timestamp. Therefore, each video frame set with the specified mark may correspond to one timestamp. The timestamp of each video frame corresponds to one position of the first progress bar. Therefore, the user may intuitively know a position of each marked video frame on the progress bar by displaying the specified mark on the first progress bar. Therefore, after setting the specified mark for the target video frame, the method further includes: determining the timestamp of the target video frame corresponding to the specified mark; determining a target position corresponding to the timestamp in the first progress bar corresponding to the plurality of video frames; displaying the specified mark at the target position of the first progress bar. The first progress bar may be displayed on the screen during the screen displaying the plurality of video frames.

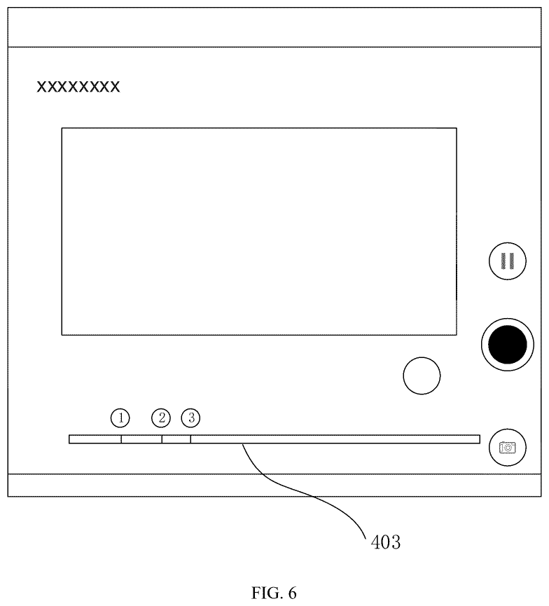

Exemplarily, the first progress bar corresponds to a plurality of time points. Each of the plurality of time points corresponds to one timestamp of the video frame. For example, there may be four video frames, a frame 1, a frame 2, a frame 3, and a frame 4. The frame 1 may correspond to a timestamp of T1, the frame 2 may correspond to a timestamp of T2, the frame 3 may correspond to a timestamp of T3, and the frame 4 may correspond to a timestamp of T4. The first progress bar may have a plurality of time points correspondingly, including a time point 1, a time point 2, a time point 3, and a time point 4. For example, on the first progress bar, time may gradually increases along an extending direction of a time axis. Therefore, along the extending direction of the time axis, the time point 1 may correspond to the timestamp T1, the time point 2 may correspond to the timestamp T2, the time point 3 may correspond to the timestamp T3, and the time point 4 may correspond to the timestamp T4. When the first progress bar is displayed on the screen, each time point on the first progress bar corresponds to one position on the first progress bar. Therefore, after determining the target video frame, the target position of the target video frame on the first progress bar may be determined, such that the specified mark may be correspondingly displayed at the target position of the first progress bar. Exemplarily, correspondingly displaying the specified mark at the target position of the first progress bar may refer to determining a first displayed content corresponding to the specified mark. The first displayed content may be an expression of the specified mark, which may be a text, a pattern, or a number, and so on. As shown in FIG. 6, in an example, three target video frames may be marked with a mark 1, a mark 2, and a mark 3, respectively. \textcircled{1}, \textcircled{2}, and \textcircled{3} in FIG. 6 may be the first displayed contents corresponding to the three specified marks and may correspond to the mark 1, the mark 2, and the mark 3, respectively. In this way, by displaying the first displayed contents on the first progress bar, the user may understand position relationships of the target video frames and positions of the target video frames on the time axis of the entire video file.

It is to be noted that in some embodiments, the plurality of video frames may be played relatively fast, and the user may input the touch operation on the preset component relatively slowly. When the preset component is detected as being touched, a time point at which the touch operation performed on the preset component is detected may be determined. A keyframe immediately earlier than the time point of the touch operation may be determined as the target video frame corresponding to the touch operation. Since the keyframe may cover key information of a video, the keyframe may serve as a representative of video contents of the video. Since a visual reflection speed of the user may be faster than a touch reflection speed of the user, by applying the keyframe as the target video frame, inaccurate marking of the video frame, caused by the touch operation being input excessively slowly, may be avoided. Furthermore, in a later process of editing the video, the specified mark corresponding to the keyframe may be changed, i.e., the video frame of interest may be finely changed.

Therefore, in the present embodiment, in the case that the plurality of video frames are displayed on the screen of the electronic device, the user may conveniently and quickly mark the video frame of interest by performing the first preset operation, so as to provide reference for subsequent video processing and editing.

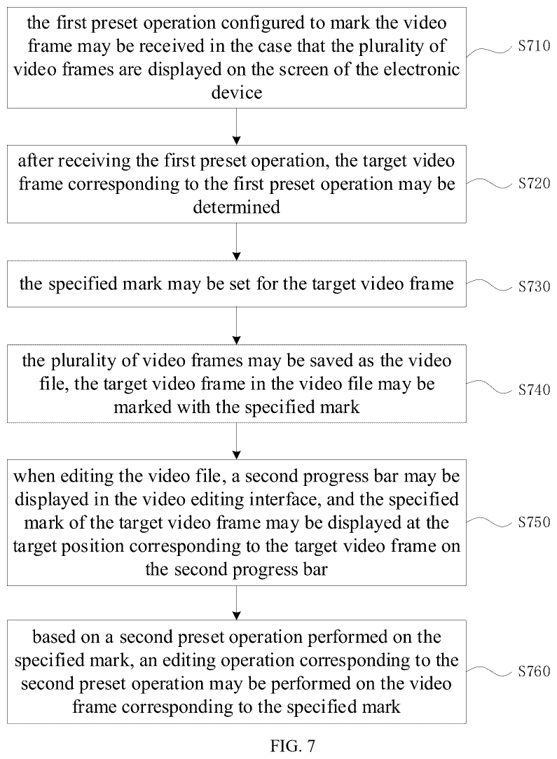

As shown in FIG. 7, FIG. 7 is a flow chart of the image processing method according to another embodiment of the present disclosure. The method may be performed by the electronic device, and specifically, the method may include operations S710 to S760.

In an operation S710, the first preset operation configured to mark the video frame may be received in the case that the plurality of video frames are displayed on the screen of the electronic device.

In an operation S720, after receiving the first preset operation, the target video frame corresponding to the first preset operation may be determined.

In an operation S730, the specified mark may be set for the target video frame.

To be noted that implementation of the operations S710 to S730 may be referred to the above embodiments and will not be repeated herein.

In an operation S740, the plurality of video frames may be saved as the video file, the target video frame in the video file may be marked with the specified mark.

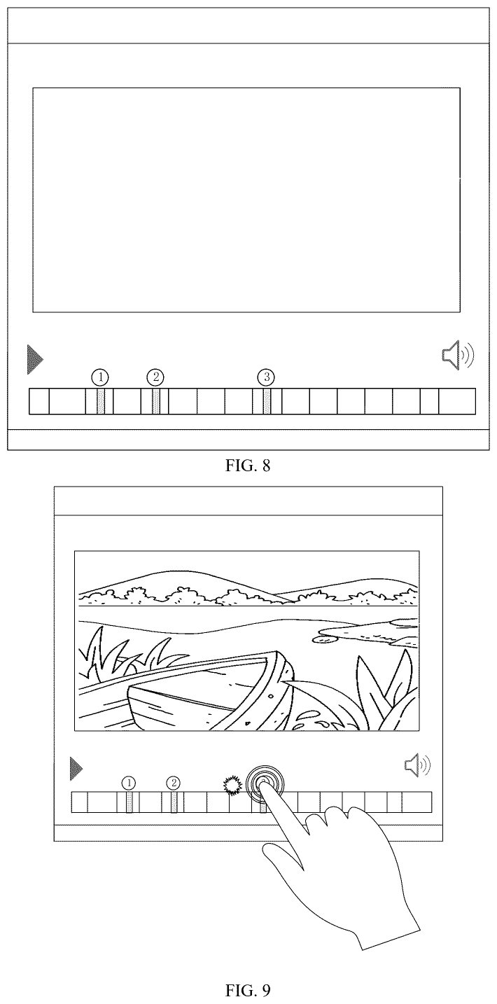

In an embodiment, the specified mark may be used as a label of that target video frame. As shown in the above Table 1, the specified mark may correspond to the name and the timestamp of the target video frame. After the user finishes marking the video frame of interest in the video playing interface, the plurality of video frames may be saved as the video file. For example, when performing video recording, during performing the video recording, the user may set the specified mark for the video frame displayed in the video recording interface. At the time when the video recording is finished, the electronic device may save a video having the specified mark and a video without the specified mark as the video file according to the timestamp of each respective video frame. When the user triggers playing the video file, each specified mark may be seen on the playing progress bar in the playing interface corresponding to the video file. As shown in FIG. 8, the playing progress bar may be displayed in the video playing interface corresponding to the video file, similar to the first progress bar, each position on the playing progress bar may correspond to the timestamp of each respective video frame. To be noted that the video playing interface may be different from the above situation where the specified marker may be set for the video frame when the plurality of video frames are displayed on the screen of the electronic device, which may be two different stages. Alternatively, the video playing interface may be the same as the above situation where the specified marker may be set for the video frame when the plurality of video frames are displayed on the screen of the electronic device. The present disclosure does not limit the above two stages. In the present embodiment, the interface in the operations S710 to S730 in which the plurality of video frames are displayed may be the video recording interface, and the interface in which the video file is played after the operation S740 may be the video playing interface.

Therefore, according to the specified mark corresponding to the target video frame determined in the video playing stage, the specified mark may be displayed, on the playing progress bar of the video editing interface, at the target position corresponding to the timestamp of the target video frame. As shown in FIG. 8, a thumbnail image corresponding to each video frame may be displayed on the playing progress bar. Specifically, thumbnail images of a plurality of video frames may be displayed sequentially based on positions of timestamps of the plurality of video frames on the playing progress bar. When the first touch operation is input to the specified mark on the playing progress bar in the video playing interface corresponding to the video file, the video frame corresponding to the triggered specified mark may be determined, a playing progress of the video may be adjusted to a position of the video frame corresponding to the specified mark on the playing progress bar, and the video frame corresponding to the triggered specified mark may be displayed in the video displaying region of the video playing interface. As shown in FIG. 9, in an example, the specified mark \textcircled{3} may be touched (such as being single clicked), the video frame corresponding to the specified mark \textcircled{3} may be displayed in the video displaying region of the video playing interface, and the playing progress of the playing progress bar may be adjusted to a position corresponding to the specified mark \textcircled{3} in the playing progress bar. Therefore, the video frame corresponding to the specified mark may be quickly located and played based on the specified mark on the playing progress bar.

In an operation S750, when editing the video file, a second progress bar may be displayed in the video editing interface, and the specified mark of the target video frame may be displayed at the target position corresponding to the target video frame on the second progress bar.

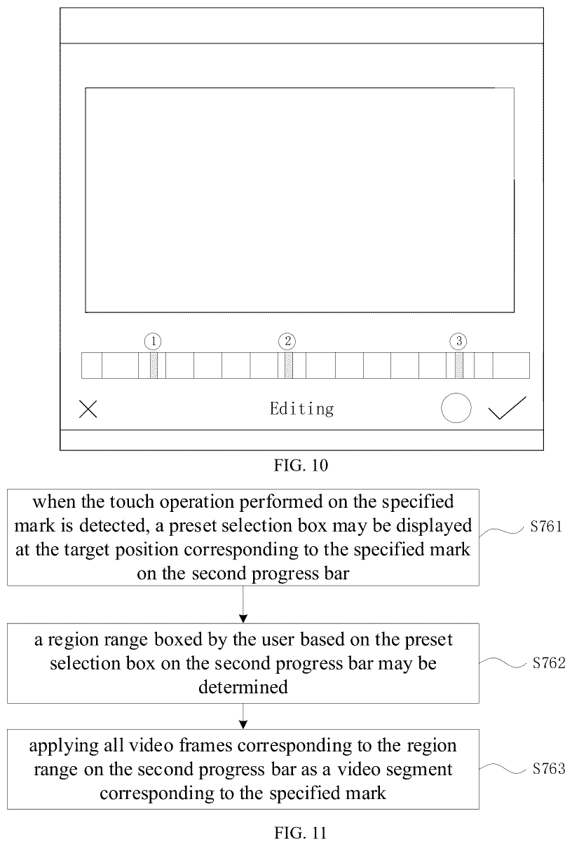

In an embodiment, after the target video frame is set by the user with the specified mark, the target video frame may be saved as the video file. The video file may be selected from a video list of the electronic device, and a video editing interface for the video file may be displayed. As shown in FIG. 10, the second progress bar may be displayed in the video editing interface, similar to the first progress bar, each position on the second progress bar may correspond to the timestamp of each respective video frame. Therefore, based on the specified mark corresponding to the target video frames determined in the video playing stage, the specified mark may be displayed at the target position corresponding to the timestamp of the target video frame on the second progress bar of the video editing interface. The position corresponding to the target video frame on the second progress bar may be quickly located based on the displayed specified mark.

In an embodiment, the electronic device may display a video editing interface based on an editing request for a video file. The editing request for the video file may be triggered by the user based on a touch operation performed on a video editing control after selecting the video file from the video list. Of course, displaying the video editing interface may be triggered based on the touch operation performed on the specified mark in the video playing interface as described above. Exemplarily, when the touch operation performed on any specified mark is detected in the video playing interface shown in FIG. 8, the video editing interface for the video file may be entered.

In an operation S760, based on a second preset operation performed on the specified mark, an editing operation corresponding to the second preset operation may be performed on the video frame corresponding to the specified mark.

Exemplarily, in the video editing interface of the video file, the user may input the second preset operation for one specified mark, in order to perform the editing operation on the video frame corresponding to the specified mark. For example, the video frame corresponding to the specified mark may be changed, or, the timestamp of the video frame corresponding to the specified mark in the video file may be adjusted.

In an embodiment, by inputting the second preset operation on the specified mark, the video frame corresponding to the specified mark may be changed. When a plurality of video frames are displayed on the screen of the electronic device, the video frame corresponding to the specified mark may be the target video frame. In this case, in the editing interface of the video file, before the video frame corresponding to the specified mark is changed, the video frame corresponding to the specified mark on the second progress bar may be the target video frame. When the second preset operation is input for the specified mark, the target video frame corresponding to the specified mark may be changed to at least one another video frame. The at least one another video frame may or may not include the target video frame.

Exemplarily, as shown in FIG. 11, the operation S760 may include operations S761 to S763. The operations S761 to S763 may be noted as the first editing operation, and the aforementioned second preset operation may be a touch operation.

In an operation S761, when the touch operation performed on the specified mark is detected, a preset selection box may be displayed at the target position corresponding to the specified mark on the second progress bar.

In an embodiment, the touch operation, which is detected as being performed on the preset component in the case of the plurality of video frames being displayed on the screen of the electronic device, may be recorded as a first touch operation. A touch operation, which is detected as being performed on the specified mark in the video editing interface, may be recorded as a second touch operation. The second touch operation may be a single-click operation, a continuous-click operation, or a long-press operation. In the present embodiment, the second touch operation may be the single-click operation. To be noted that in the case that the second touch operation performed on the specified mark in the video editing interface is detected, the electronic device enters an editing mode for the specified mark. In an editing mode for the specified mark, a preset selection box corresponding to the specified mark may be displayed.

In an operation S762, a region range boxed by the user based on the preset selection box on the second progress bar may be determined.

In an operation S763, applying all video frames corresponding to the region range on the second progress bar as a video segment corresponding to the specified mark.

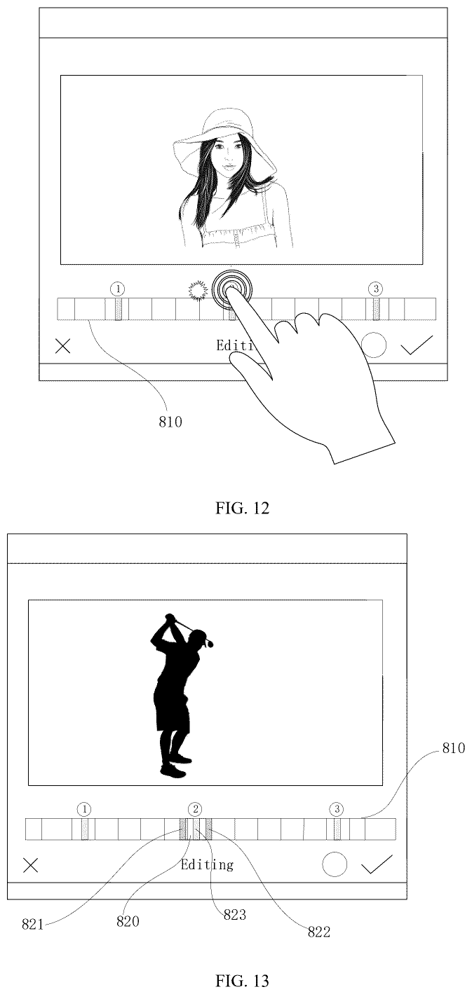

As shown in FIG. 12, the single-click operation (i.e., the second touch operation) may be input to the specified mark \textcircled{2} in the video editing interface. A video frame displayed in the video editing interface shown in FIG. 12 may be a first video frame of the video file. When the electronic device detects the single-click operation performed on the specified mark \textcircled{2}, the preset selection box may be displayed at a target position corresponding to the specified mark \textcircled{2} on the second progress bar 810. The target position may be a position corresponding to the timestamp of the target video frame corresponding to the specified mark \textcircled{2} on the second progress bar. For example, the second progress bar may be similar to the aforementioned playing progress bar, the second progress bar may display a video thumbnail of each video frame. A video thumbnail of the target video frame corresponding to the specified mark \textcircled{2} may be displayed at the target position corresponding to the specified mark \textcircled{2} on the second progress bar. As shown in FIG. 13, the video frame displayed in the video editing interface may be the target video frame corresponding to the specified mark \textcircled{2}. The preset selection box 820 may be displayed at the target position corresponding to the specified mark \textcircled{2} on the second progress bar 810. A size and a position of the preset selection box 820 may be adjusted, such that a region range that is boxed by the preset selection box 820 on the second progress bar may be adjusted. Based on the foregoing description, various positions on the second progress bar may correspond to different video frames. Therefore, by adjusting the region range boxed by the preset selection box 820 on the second progress bar, video frames boxed by the preset selection box 820 may be adjusted, and all video frames corresponding to the region range on the second progress bar may be applied as the video segment corresponding to the specified mark. In this way, all video frames of the video segment may correspond to the specified mark \textcircled{2}. When a plurality of video frames are displayed on the screen of the electronic device, the target video frame, which is set by the user through the preset component and corresponds to the specified mark \textcircled{2}, may be a video frame 10. In this case, in the video editing interface, the specified mark \textcircled{2} may be displayed at a position of the video frame 10 on the second progress bar, and the preset selection box 820 may be arranged at the position of the video frame 10 on the second progress bar. The user may adjust the region range of the preset selection box 820 corresponding to the specified mark \textcircled{2}, enabling a plurality of video frames corresponding to the adjusted region range of the preset selection box 820 to include a video frame 8 to a video frame 14, such that the video segment corresponding to the specified mark \textcircled{2} may be the video frame 8 to the video frame 14. That is, the target video frame corresponding to the specified mark \textcircled{2} may be changed from the video frame 10 to a plurality of video frames from the video frame 8 to the video frame 14, i.e., new target video frames may be the video frame 8 to video frame 14.

In an embodiment, in order to facilitate the user to adjust the region range selected by the preset selection box on the second progress bar, the preset selection box 820 may include a first box 821, a second box 822, and a centerline region 823. The first box 821 and the second box 822 may be respectively located at a left side and a right side of the centerline region 823. The centerline region 823 may be located at the target position of the second progress bar 810. By adjusting positions of the first box 821 and/or the second box 822, the region range of the present selection box may be changed.

Exemplarily, determining the region range boxed by the user on the second progress bar based on the preset selection box may be achieved by changing a position of a specified box on the second progress bar based on a detected sliding operation performed on the specified box. The specified box may be at least one of the first box and the second box. When the sliding operation is completed, a region between the first box and the second box may be taken as the boxed region range. As shown in FIG. 13, the region between the first box and the second box may be taken as the preset selection box, and the region may include regions occupied by the first box and the second box.

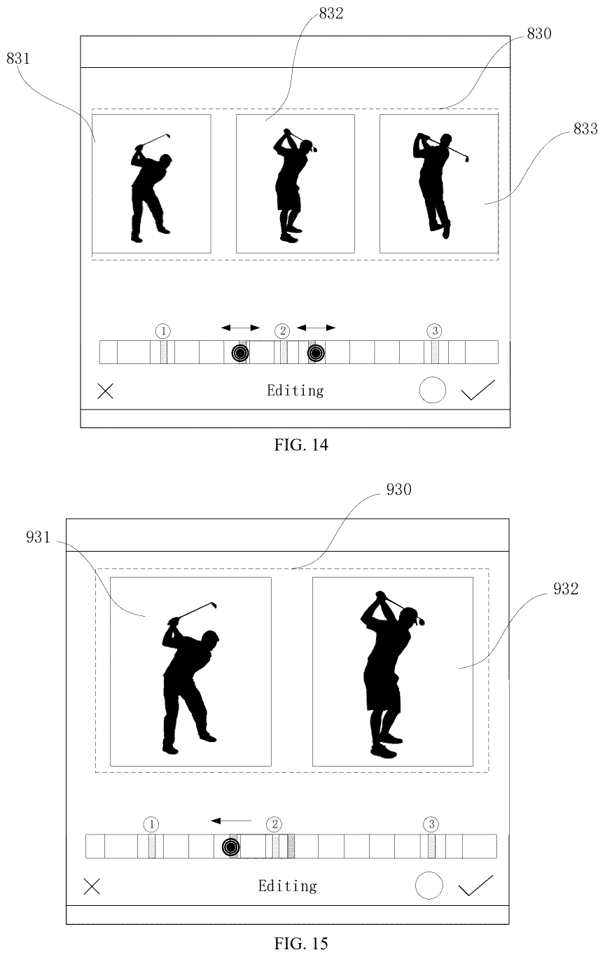

As shown in FIG. 14, both the first box and the second box may be dragged along the second progress bar based on the sliding operation input by the user. Exemplarily, when the user presses the first box and/or the second box and drags the first box and/or the second box, and the first box and the second box may move approaching or away from the centerline region. The electronic device may detect the sliding operation performed on the first box and/or the second box. During performing the sliding operation, the electronic device may capture in real time positions of the first box and/or the second box on the second progress bar. When the sliding operation is stopped, the electronic device may obtain a video segment corresponding to the region between the first box and the second box on the second progress bar as the video segment corresponding to the specified mark.

In an embodiment, in order to facilitate the user to acknowledge video contents of selected video frames during dragging the first box and the second box to change the video frames corresponding to the specified mark, during the sliding operation, a specified position of the specified box on the second progress bar may be determined. The video frames corresponding to the specified position on the second progress bar may be displayed in the video editing interface. The term of during the sliding operation may refer to an operation performed between a touch start time point of the sliding operation and a touch end time point of the sliding operation. Exemplarily, the user entering one sliding operation may be achieved by performing a first long press, performing dragging, stopping the dragging, and holding the long press. Therefore, the sliding operation may include the touch start time point, a dragging time period, and the touch end time point. The first touch operation may refer to a touch operation performed before the dragging operation (such as the long press), and the second touch operation may refer to a touch operation performed after the dragging operation being completed (such as the long press).

In an example, before the sliding operation, the target video frame corresponding to the specified mark \textcircled{2} may be the video frame 10. During a sliding process of the sliding operation, when the specified box is detected as reaching a position of one video frame on the second progress bar, the video frame corresponding to the position may be displayed in the video editing interface. As shown in FIG. 14, a displaying region 830 of the video editing interface may be divided into a first region 831, a second region 832, and a third region 833. The first region 831 may be configured to display a video frame corresponding to the position of the first box on the second progress bar, the third region 833 may be configured to display a video frame corresponding to the position of the second box on the second progress bar, and the second region 832 may be configured to display the target video frame. In this way, the video frame at the position corresponding to each box during the sliding process may be clarified, and a content change between the video frame corresponding to the box and the target video frame may be determined based on the target video frame displayed in the second region 832. In this way, the user may be facilitated to determine, based on contents displayed in the first region 831, the second region 832, and the third region 833, the region range boxed by the preset selection box on the second progress bar.

In an embodiment, when the user is operating the electronic device, especially when the electronic device is a mobile terminal, one hand may hold the electronic device, and the other hand may drag the first box or the second box. Therefore, the displaying region of the video editing interface may be divided into two regions, one of the two regions may display the target video frame, and the other one of the two regions may display the video frame corresponding to the first box or the second box, such that user usage habits may be met.

Exemplarily, the specified box may be the first box, and the user adjusting the region range boxed by the preset selection box on the second progress bar may be achieved by the following. The user may input the sliding operation on the first box to change the position of the first box on the second progress bar to adjust the region range boxed by the preset selection box on the second progress bar. Displaying the video frame corresponding to the specified position on the second progress bar in the video editing interface may be achieved by: displaying the video frame corresponding to the specified position of the first box on the second progress bar in the first region of the video editing interface; and displaying the target video frame in the second region of the video editing interface. The first region may be located closer to a start position of the second progress bar than the second region is. As shown in FIG. 15, the displaying region 930 of the video editing interface may include the first region 931 and the second region 932. The first region 931 may be located at a left of the second region 932. That is, the start position of the second progress bar is located at a leftmost end of the second progress bar. The video frame corresponding to the specified position of the first box during the sliding process may be displayed in the first region. To be noted that, since the specified position of the first box on the second progress bar may be changed during the sliding process, the video frame displayed in the first region may be changed accordingly as the specified position of the first box on the second progress bar is changed, but the displayed video frame may keep being synchronized with the video frame at the position of the first box on the second progress bar. Moreover, the first box is located closer to the start position of the second progress bar than the centerline region, i.e., the first box may be located at the left of the centerline region, and the first box may be moved within a region between the start position of the second progress bar and the centerline region. Therefore, the video frame corresponding to the specified position of the first box on the second progress bar may be displayed at a left of the target video frame corresponding to the centerline region, in this way, an operation direction and a displaying distribution direction may be consistent with each other, improving the user experience.

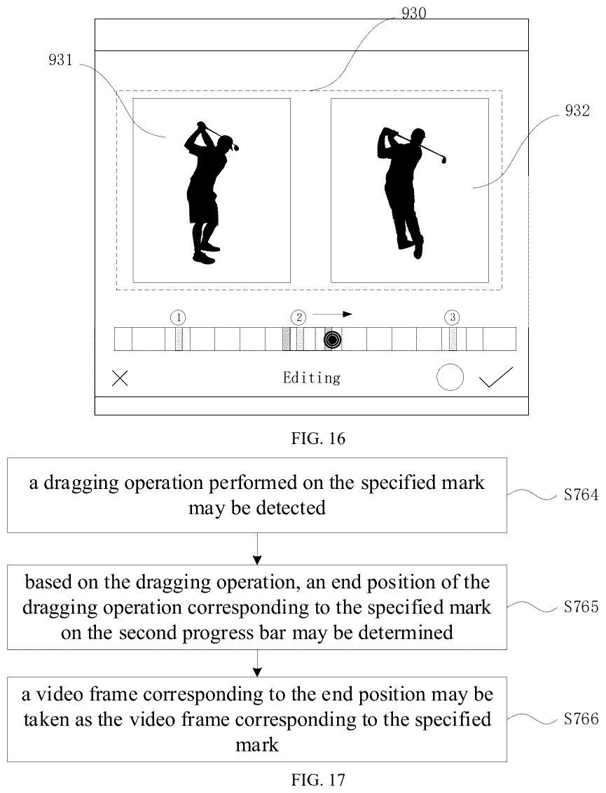

Similarly, when the specified border is the second box, the user adjusting the region range boxed by the preset selection box on the second progress bar may be achieved by the following. The user may input the sliding operation on the second box to change a position of the second box on the second progress bar to adjust the region range boxed by the preset selection box on the second progress bar. Displaying the video frame corresponding to the specified position on the second progress bar in the video editing interface may be achieved by: displaying the target video frame in the first region of the video editing interface; and displaying a video frame corresponding to the specified position of the second box on the second progress bar in the second region of the video editing interface. The first region is located closer to the start position of the second progress bar than the second region is. As shown in FIG. 16, the display region 930 of the video editing interface may include the first region 931 and the second region 932. The first region 931 may be located at the left of the second region 932. That is, the start position of the second progress bar may be located at the leftmost end of the second progress bar. The video frame corresponding to the specified position of the first box during the sliding process may be displayed in the first region. To be noted that, since the specified position of the second box on the second progress bar may be changed during the sliding process, the video frame displayed in the second region may be changed accordingly as the specified position of the second box on the second progress bar is changed, but the displayed video frame may be synchronized with the video frame at the position of the second box on the second progress bar. Moreover, the second box is located further away from the start position of the second progress bar than the center line region, i.e., the second box may be located at the right of the centerline region, and the second box may move within a region between an end position of the second progress bar and the centerline region. Therefore, by displaying the video frame corresponding to the specified position of the second box on the second progress bar at a right of the target video frame corresponding to the centerline region, the operation direction and the displaying distribution direction may be consistent with each other, improving the user experience.

In summary, the manner in which the contents are displayed in each displaying region may be adaptively adjusted based on the operation performed by the user on the first box and/or the second box. Specifically, in an example, the first box and the second box may be dragged at the same time, as shown in an interface shown in FIG. 14, video frames, during the sliding operation, corresponding to the first box, the second box, and the centerline region may all be displayed. When the first box is dragged, as shown in an interface shown in FIG. 15, video frames, during the sliding operation, corresponding to the first box and the center line region may be displayed. When the second box is dragged, as shown in an interface shown in FIG. 16, video frames, during the sliding operation, corresponding to the second box and the center line region may be displayed. Moreover, after the dragged box is changed, the displayed contents may be changed in accordance with the interfaces shown in FIG. 14, FIG. 15, and FIG. 16, specific operations may not be repeated herein.

It should be noted that, when the sliding operation is completed, the plurality of regions in the display region may be restored to one complete displaying region, and the target video frame may be displayed in the display region. For example, as shown in FIG. 16, when the sliding operation performed on the second box is completed, i.e., when the long press operation performed on the second box is stopped, contents displayed in the displaying region of FIG. 16 may be changed to be the target video frame, i.e., one image may be displayed.

In another embodiment, in addition to changing the video segment corresponding to the specified mark by the above-described means, the target video frame corresponding to the specified mark may be changed by dragging the specified mark to change the position of the specified mark on the second progress bar. As shown in FIG. 17, the operation S760 may further include operations S764 to S766. The operations S764 to S766 may be noted as a second editing operation, and the second preset operation may be a dragging operation.

In an operation S764, a dragging operation performed on the specified mark may be detected.

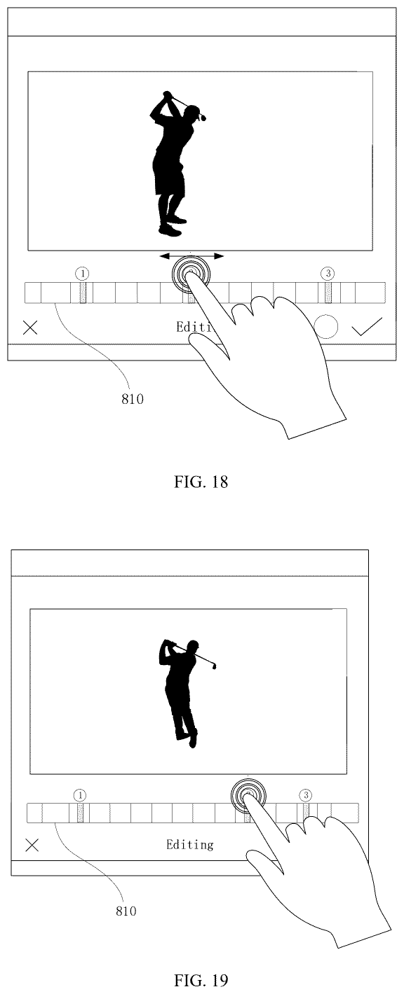

In an embodiment, within the video editing interface, when the single-click operation performed on the specified mark is detected, the preset selection box may be displayed at a target position corresponding to the specified mark on the second progress bar. When the dragging operation performed on the specified mark is detected, the preset selection box of the specified mark may be not displayed, and the specified mark may be dragged to move along the extending direction of the time axis of the second progress bar. As shown in FIG. 18, in an editing mode for the specified mark \textcircled{2}, the user may drag the specified mark \textcircled{2} reciprocately along the second progress bar.

In an operation S765, based on the dragging operation, an end position of the dragging operation corresponding to the specified mark on the second progress bar may be determined.

In an operation S766: a video frame corresponding to the end position may be taken as the video frame corresponding to the specified mark.

To be noted that, when the plurality of video frames are displayed on the screen of the electronic device, the video frame corresponding to the specified mark \textcircled{2} marked by the user through the preset component may be the target video frame. As shown in FIG. 18, when entering the video editing interface, the specified mark \textcircled{2} may be detected as being touched, the target video frame corresponding to the specified mark \textcircled{2} may be displayed. Subsequently, as shown in FIG. 19, as compared to FIG. 18, the specified mark \textcircled{2} may be dragged by the user to a new position on the second progress bar, such that the video frame corresponding to the specified mark \textcircled{2} may be changed from the target video frame in FIG. 18 to a new video frame in FIG. 19. Therefore, the video frame shown in FIG. 19 may be the video frame corresponding to the end position of the specified mark on the second progress bar at the end of the dragging operation. That is, that the target video frame corresponding to specified mark \textcircled{2} may be changed to the video frame corresponding to the end position.

To be noted that an operation corresponding to operations S761 to S763 may be named as the first editing operation, and the operation corresponding to operations S764 to S766 may be named as the second editing operation. The first editing operation and the second editing operation may be respectively triggered based on the single-click operation and the dragging operation performed by the user on the specified mark in the video editing page corresponding to the video file. That is, under the single-click operation, the first editing operation may be performed; and under the dragging operation, the second editing operation may be performed. Alternatively, both the first editing operation and the second editing operation may be performed. For example, after the first editing operation is completed, the user may drag the specified mark on the second progress bar, and the preset selection box corresponding to the specified mark (which may be the preset selection box corresponding to the specified mark at the end of the first editing operation) may move as the specified mark moves. The preset selection box may be displayed at the end position corresponding to the specific mark on the second progress bar at the end of the dragging operation. For example, the centerline region of the preset selection box may coincide with the end position corresponding to the specified mark on the second progress bar at the end of the operation. Alternatively, after the second editing operation is completed, the first editing operation may be performed. In this case, the target position corresponding to the first editing operation may be the end position corresponding to the second editing operation. Specific implementation may be referred to the foregoing embodiment, and will not be repeated herein.

To be noted that the first editing operation and the second editing operation in the above may be performed in the editing mode for the certain specified mark. Therefore, the operation S761 may be performed as follows. When the touch operation performed on the specified mark is detected, the editing mode for the specified mark may be entered. In the editing mode for the specified mark, the preset selection box may be displayed at the target position corresponding to the specified mark on the second progress bar. Similarly, the operation S764 may be performed as follows. When the touch operation performed on the specified mark is detected, the editing mode for the specified mark may be entered. In the editing mode for the specified mark, the dragging operation performed on the specified mark may be detected. That is, the editing mode for the specified mark may be entered by firstly performing the single-click operation on the specified mark, and subsequently, the video frame corresponding to the specified mark may be adjusted.

In addition, the dragging operation performed on the specified mark may be to change the position of the video frame corresponding to the specified mark in the second progress bar. Of course, the dragging operation may be the dragging operation performed on specified mark, i.e., the operation of taking the video frame corresponding to the end position as the video frame corresponding to the specified mark may be performed, alternatively, the operation of changing the position of the video frame corresponding to the specified mark on the second progress bar (which may be named as a third editing operation) may be performed. That is, the dragging operation performed on the specified mark may trigger the second editing operation or the third editing operation to be performed. Of course, it may be determined, based on whether the editing mode for the specified mark is entered, whether to perform the second editing operation or the third editing operation. Exemplarily, the second editing operation may be performed when the editing mode of the specified mark is entered, and the third editing operation may be performed when the editing mode of the specified mark is not entered. That is, in the video editing interface corresponding to the video file, when the specified mark is firstly touched and the dragging operation is subsequently input for the specified mark, the second editing operation corresponding to the specified mark may be performed. When the dragging operation for the specified mark is directly input in the video editing interface corresponding to the video file, the third editing operation corresponding to the specified mark may be performed. Subsequently, the editing mode for the specified mark may be entered by performing the single-click operation on the specified mark.

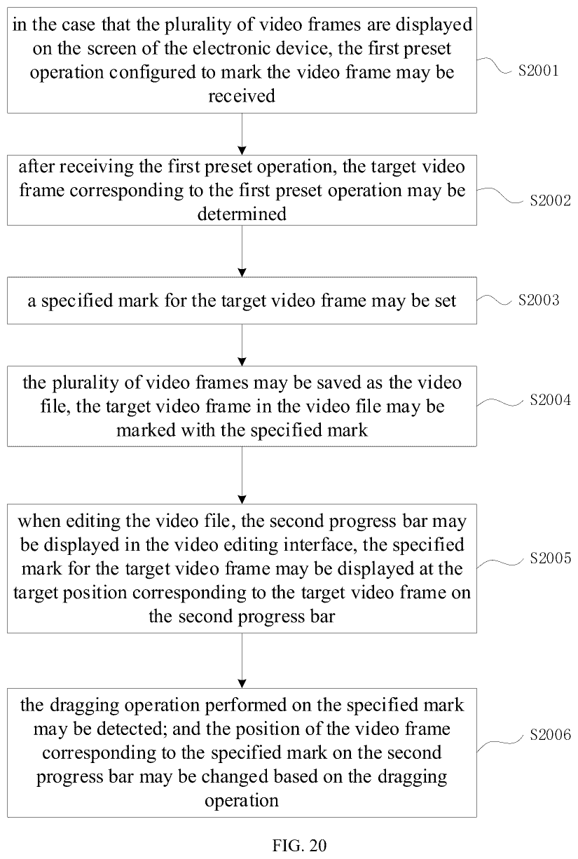

As shown in FIG. 20, the third editing operation may be shown in FIG. 20, i.e., FIG. 20 is a flow chart of the image processing method according to still another embodiment of the present disclosure. The method may include operations S2001 to S2006.

In an operation S2001, in the case that the plurality of video frames are displayed on the screen of the electronic device, the first preset operation configured to mark the video frame may be received.

In an operation S2002, after receiving the first preset operation, the target video frame corresponding to the first preset operation may be determined.

In an operation S2003, a specified mark for the target video frame may be set.

In an operation S2004, the plurality of video frames may be saved as the video file, the target video frame in the video file may be marked with the specified mark.

In an operation S2005, when editing the video file, the second progress bar may be displayed in the video editing interface, the specified mark for the target video frame may be displayed at the target position corresponding to the target video frame on the second progress bar.

To be noted that implementation of the operations S2001 to S2005 may be referred to the above embodiments and will not be repeated herein.

In an operation S2006, the dragging operation performed on the specified mark may be detected; and the position of the video frame corresponding to the specified mark on the second progress bar may be changed based on the dragging operation.

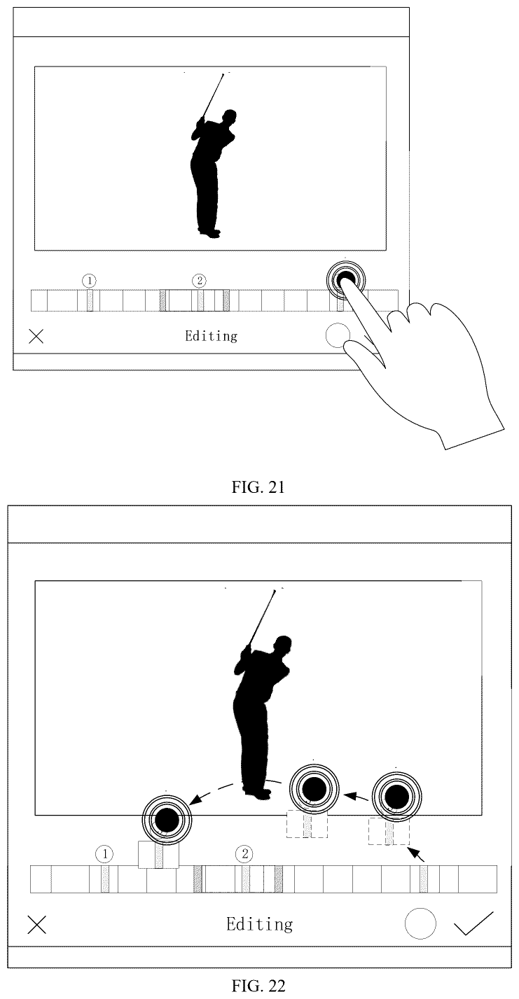

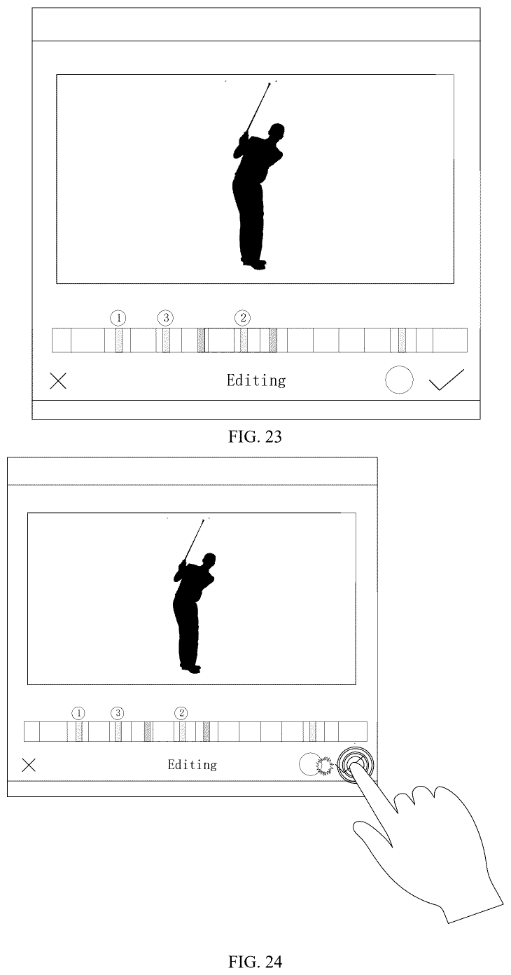

In an embodiment, the user may long-press the specified mark in the video editing interface corresponding to the video file, such that the specified mark may be dragged. The user may drag all video frames corresponding to the specified mark to move. When the dragging operation is completed, all video frames corresponding to the specified mark may be moved to the new position on the second progress bar. In this way, timestamps of all video frames corresponding to the specified mark in the video file may be changed. As shown in FIG. 21, the interface shown in FIG. 21 may be a video editing interface under an editing mode for non-specified marks, the user may long-press the specified mark \textcircled{3} to enable the specified mark \textcircled{3} to be dragged. As shown in FIG. 22, the specified mark \textcircled{3} and all video frames corresponding to the specified mark \textcircled{3} may be moved in accordance with a dragging gesture of the user. As shown in FIG. 23, at the end of the dragging gesture, the specified mark \textcircled{3} and all the video frames corresponding to the specified mark \textcircled{3} may be inserted at a position corresponding to an end position of the dragging operation on the second progress bar. By comparing FIG. 21 to FIG. 23, the dragging operation performed on the specified mark \textcircled{3} enables the specified mark \textcircled{3} and all video frames corresponding to the specified mark \textcircled{3} to be inserted between the position corresponding to the specified mark \textcircled{1} and the position corresponding to the specified mark \textcircled{2}.

To be noted that, in addition to the aforementioned determination, based on whether or not the single-click operation performed on the specified mark is input in the video editing interface, of whether the current editing mode is the editing mode for the specified mark or the editing mode for non-specified marks, in an example, when a default mode in the video editing interface of the video file may be the editing mode for non-specified marks, i.e., when no second touch operation (such as the single-click operation) is detected as being performed on the specified mark after entering the video editing interface of the video file, the editing mode for non-specified marks may be maintained. When the second touch operation is detected as being performed on the specified mark, the editing mode for the specified mark may be entered.

After entering the editing mode for the specified mark, the editing mode for the specified mark may be exited, and then the editing mode for non-specified marks may be entered. For example, in the editing mode for the specified mark, when the second touch operation performed on the specified mark is detected again, the editing mode for the specified mark may be exited, and the editing mode for non-specified marks may be entered. For example, in the editing mode for the specified mark, when the touch operation is detected as being performed in a specified region of the video editing interface, the editing mode for the specified mark may be exited, and then the editing mode for non-specified marks may be entered. Exemplarily, the specified region may be a blank region or any other region of the video editing interface, which are not limited herein.

In the case that the video editing interface is displayed, the editing mode for the specified mark is entered, and after performing the aforementioned first editing operation and second editing operation in the editing mode for the specified mark, and after exiting the editing mode for the specified mark and then entering the editing mode for non-specified marks, the third editing operation may be performed, by performing the dragging operation on the specified mark, in the editing mode for non-specified marks.

After performing at least one of: the first editing operation, the second editing operation, and the third editing operation, the user may save a video file after performing the video editing operations.

As shown in FIG. 24, the user may click a save button of the video editing interface to save the video file after performing the video editing operations. Specific saving methods may include segment saving, splicing saving, and marked frame image saving.

In an embodiment, the segment saving may refer to the following. When a plurality of video frames correspond to the specified mark, the plurality of video frames corresponding to each specified mark may be saved as one video file, i.e., a second video file. Exemplarily, the segment saving means that, after performing the above editing operations, at least one specified mark may correspond to the plurality of video frames, i.e., at least one specified mark may correspond to a video segment. The video segment corresponding to each of the at least one specified mark may be saved as one video file. For example, after performing the above editing operations, the specified mark \textcircled{1} may correspond to a first video segment, the specified mark \textcircled{2} may correspond to a second video segment, and the specified mark \textcircled{3} may correspond to a third video frame. By performing the segment saving, the first video segment may be saved as a video file 1, the second video segment may be saved as a video file 2, and the third video frame may be saved as one image.

In an embodiment, the splicing saving may refer to the following. All video frames corresponding to all specified marks may be combined and saved as one first video file. Exemplarily, the splicing saving may mean that all video frames corresponding to all specified marks are integrated into one video segment and saved as one video file. Exemplarily, all video frames corresponding to all specified marks may be integrated into one video segment and saved as one video file based on the timestamps of each video frame. The timestamp of the video frame may refer to a timestamp after the editing operation is completed.

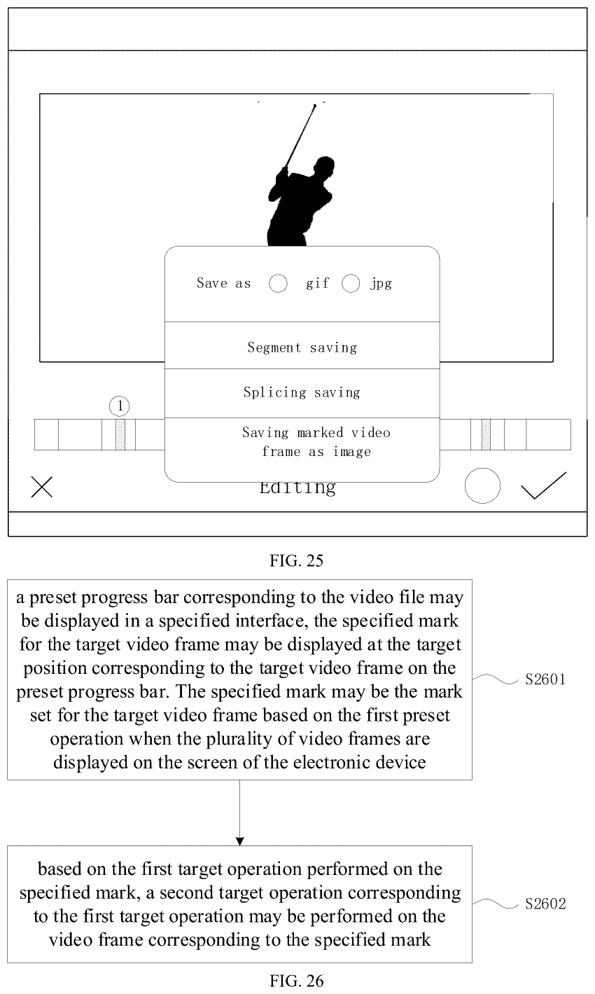

In an embodiment, the marked frame image saving may refer to the following. When one video frame corresponds to the specified mark, the video frame corresponding to the specified mark may be saved as a target image. Of course, one video frame may be determined from the plurality of video frames corresponding to the specified mark and saved as the target image. Exemplarily, the marked frame image saving may mean that all specified marks do not correspond to any video segment, and each specified mark corresponds to one video frame, and the video frame corresponding to each specified mark may be saved as one image. As shown in FIG. 25, a save selection interface may be displayed after clicking the save button of the video editing interface, at least one saving method may be selected from the segment saving, the splicing saving, and the marked frame image saving, so as to save the edited video file.

As shown in FIG. 26, FIG. 26 is a flow chart of the image processing method according to still another embodiment of the present disclosure. The method may include operations S2601 and S2602.

In an operation S2601, a preset progress bar corresponding to the video file may be displayed in a specified interface, the specified mark for the target video frame may be displayed at the target position corresponding to the target video frame on the preset progress bar. The specified mark may be the mark set for the target video frame based on the first preset operation when the plurality of video frames are displayed on the screen of the electronic device.

Setting the specified mark for the target video frame may be referred to the above embodiment and will not be repeated herein.

In an operation S2602, based on the first target operation performed on the specified mark, a second target operation corresponding to the first target operation may be performed on the video frame corresponding to the specified mark.

The second target operation may be the above editing operation and a playing operation, and of course, the second target operation may alternatively be other operations, which are not limited herein.

In an embodiment, the specified interface may include a video editing interface, the preset progress bar may include the second progress bar. Performing, based on the first target operation performed to the specified mark, the second target operation corresponding to the first target operation on the video frame corresponding to the specified mark may include: performing, based on the second preset operation performed on the specified mark, an editing operation corresponding to the second preset operation on the video frame corresponding to the specified mark. The editing operation may include: detecting a touch operation performed on the specified mark, displaying the preset selection box at the target position corresponding to the specified mark on the second progress bar; determining the region range boxed by the user based on the preset selection box on the second progress bar; and taking all video frames corresponding to the region range on the second progress bar as the video segment corresponding to the specified mark. Following operations may further be included. An end position of the specified mark on the second progress bar, when the dragging operation is completed, may be determined based on the dragging operation performed on the specified mark. The video frame corresponding to the end position may be taken as the video frame corresponding to the specified mark. Following operations may further be included. A position of the video frame corresponding to the specified mark on the second progress bar may be changed based on the dragging operation performed on the specified mark.

In an embodiment, a plurality of specified mark may be set. After performing, based on the second preset operation performed on the specified mark, the editing operation corresponding to the second preset operation on the video frame corresponding to the specified mark, the method further includes: combining and saving all video frames corresponding to all of the plurality of specified marks as the first video file. When a plurality of video frames correspond to one specified mark, the plurality of video frames corresponding to the specified mark may be combined and saved as a second video file. When one video frame corresponds to one specified mark, the video frame corresponding to the specified mark may be saved as a target image.

In an embodiment, the specified interface may include the video playing interface, the preset progress bar may include the playing progress bar. Performing, based on the first target operation performed on the specified mark, the second target operation corresponding to the first target operation on the video frame corresponding to the specified mark includes: displaying, based on the first touch operation performed on the specified mark, the video frame corresponding to the specified mark in the video displaying region of the video playing interface; and adjusting the playing progress of the playing progress bar to the position corresponding to the specified mark on the playing progress bar.

To be noted that the above editing operation, jumping during playing and the saving operation of the video may be referred to the above embodiments and will not be repeated herein.

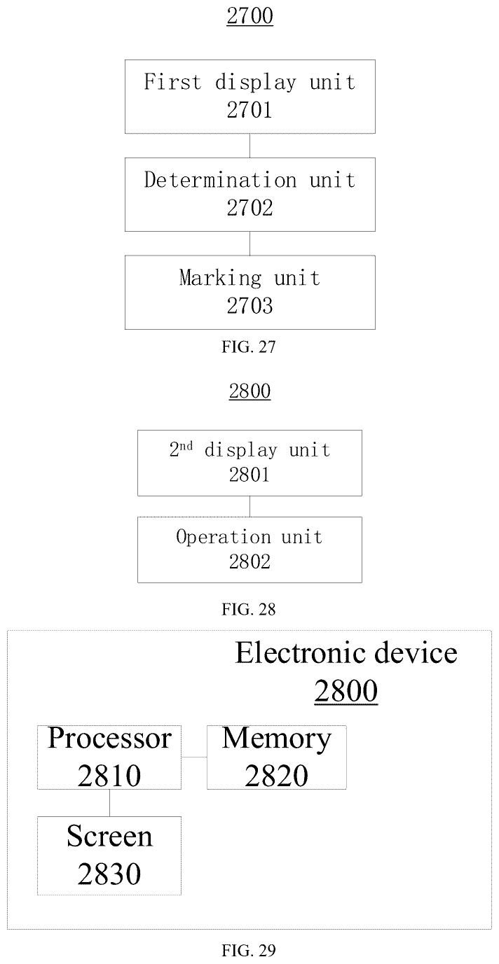

As shown in FIG. 27, FIG. 27 is a structural schematic diagram of an image processing apparatus 2700 according to an embodiment of the present disclosure. The image processing apparatus 2700 may include: a first display unit 2701, a determination unit 2702, and a marking unit 2703.

The first display unit 2701 may be configured to receive the first preset operation configured to mark at least one video frame of a plurality of video frames in the case that the plurality of video frames are displayed on the screen of the electronic device.

Further, the first display unit 2701, during a video recording operation of the electronic device, may further be configured to: display the preset component on the screen of the electronic device; and play a plurality of video frames captured during a video recording process.

The determination unit 2702 may be configured to receive the first preset operation configured to mark the at least one video frame; and determine a target video frame corresponding to the first preset operation.

The marking unit 2703 may be configured to set a specified mark for the target video frame.

Further, the marking unit 2703 may be configured to: determine a timestamp of the target video frame corresponding to the specified mark; determine a target position corresponding to the timestamp in a first progress bar corresponding to the plurality of video frames; and correspondingly display the specified mark at the target position on the first progress bar. The first progress bar may be displayed on the screen when the plurality of video frames are being displayed on the screen.

Further, the marking unit 2703 may be configured to save the plurality of video frames as the video file, the target video frame in the video file may be marked with the specified mark.

Further, the marking unit 2703 may be configured to: display the second progress bar in the video editing interface when the editing request for the video file is obtained, display the specified mark for the target video frame at the target position corresponding to the target video frame on the second progress bar; when the touch operation performed on the specified mark is detected, display the preset selection box at the target position corresponding to the specified mark on the second progress bar; determine the region range boxed by the user based on the preset selection box on the second progress bar; and take all video frames corresponding to the region range on the second progress bar as the video segment corresponding to the specified mark.

Further, the marking unit 2703 may be configured to: change the position of the specified box on the second progress bar based on the detected sliding operation performed on the specified box; and when the sliding operation is completed, take the region between the first frame and the second frame as the boxed region range. The specified box may be at least one of the first box and the second box.

Further, the marking unit 2703 may be configured to: determine the specified position of the specified box on the second progress bar between a touch start time point of the sliding operation and a touch end time point of the sliding operation; and display the video frame corresponding to the specified position on the second progress bar on the video editing interface.

Further, the first box and the second box may be respectively located on the left side and the right side of the centerline region of the preset box. The centerline region may be located at the target position of the second progress bar. The marking unit 2703 may be configured to: display, in the first region of the video editing interface, the video frame corresponding to the specified position of the first box on the second progress bar; and display the target video frame in the second region of the video editing interface. The first region may be located closer to the start position of the second progress bar than the second region is.

Further, the marking unit 2703 may be configured to: display the target video frame in the first region of the video editing interface; and display, in the second region of the video editing interface, the video frame corresponding to the specified position of the second box on the second progress bar. The first region may be located closer to the start position of the second progress bar than the second region is.

Further, the marking unit 2703 may be configured to: display the second progress bar in the video editing interface when the editing request for the video file is obtained, display the specified mark of the target video frame at the target position corresponding to the target video frame on the second progress bar; when the dragging operation performed on the specified mark is detected, determine, based on the dragging operation, an end position corresponding to the specified mark on the second progress bar when the dragging operation is completed; take the video frame corresponding to the end position as the video frame corresponding to the specified mark.

Further, the marking unit 2703 may be configured to: display the second progress bar in the video editing interface when the editing request for the video file is obtained; display the specified mark for the target video frame at the target position corresponding to the target video frame on the second progress bar; when the dragging operation performed on the specified mark is detected, change, based on the dragging operation, the position of the video frame corresponding to the specified mark on the second progress bar.

As shown in FIG. 28, FIG. 28 is a structural schematic diagram of an image processing apparatus 2800 according to another embodiment of the present disclosure. The image processing apparatus 2800 may include: a second display unit 2801 and an operation unit 2802.

The second display unit 2801 may be configured to: display the preset progress bar corresponding to the video file in the specified interface; display the specified mark for the target video frame at the target position corresponding to the target video frame on the preset progress bar. The specified mark may be a mark set for the target video frame based on the first preset operation when a plurality of video frames are displayed on the screen of the electronic device.

The operation unit 2802 may be configured to perform, based on the first target operation performed on the specified mark, the second target operation corresponding to the first target operation on the video frame corresponding to the specified mark.

Further, the operation unit 2802 may be configured to perform, based on the second preset operation performed on the specified mark, the editing operation corresponding to the second preset operation on the video frame corresponding to the specified mark.

Further, the operation unit 2802 may be configured to: detect the touch operation performed on the specified mark, display the preset selection box at the target position corresponding to the specified mark on the second progress bar; determine the region range boxed by the user based on the preset selection box on the second progress bar; take all video frames corresponding to the region range on the second progress bar as the video segment corresponding to the specified mark.

Further, the operation unit 2802 may be configured to: determine, based on the dragging operation performed on the specified mark, an end position of the specified mark on the second progress bar when the dragging operation is completed; and take the video frame corresponding to the end position as the video frame corresponding to the specified mark.

Further, the operation unit 2802 may be configured to change, based on the dragging operation performed on the specified mark, the position of the video frame corresponding to the specified mark on the second progress bar.

Further, the operation unit 2802 may be configured to combine and save all video frames corresponding to all specified marks as one first video file.

Further, the operation unit 2802 may be configured to save video frames corresponding to each specified mark as one video file.

Further, the operation unit 2802 may be configured to save the video frame corresponding to the specified mark as a target picture when one video frame corresponds to the specified mark.

Further, the operation unit 2802 may be configured to: display, based on the first touch operation performed on the specified mark, the video frame corresponding to the specified mark in the video displaying region of the video playing interface; and adjust the playing progress of the playing progress bar to the position corresponding to the specified mark on the playing progress bar.

Any ordinary skilled person in the art shall understand that, for convenience and brevity of the description, specific working processes of the above-described apparatus and modules may be referred to the corresponding processes in the method embodiments, and will not be repeated herein.

In the above embodiments, the modules may be coupled to each other electrically, mechanically or in other forms.

In addition, various functional modules in various embodiments of the present disclosure may be integrated in one processing module, or each module may physically exist separately, or two or more modules may be integrated in one module. The above integrated modules can be configured either in the form of hardware or in the form of software function modules.

As shown in FIG. 29, FIG. 29 is a structural schematic diagram of an electronic device 2800 according to an embodiment of the present disclosure. The electronic device 2800 may be an electronic device capable of running applications such as a smartphone, a tablet, an e-book, and the like. The electronic device 2800 of the present disclosure may include one or more of: a processor 2810, a memory 2820, a screen 2830, and one or more applications. The one or more applications may be stored in the memory 2820 and configured to be executed by one or more processors 2810. The one or more programs may be configured to perform the method in the above method embodiments.

The processor 2810 may include one or more processing cores. The processor 2810 may use various interfaces and wires to connect various components in the entire electronic device 2800 to each other to perform various functions and to process data of the electronic device 2800 by running or executing instructions, programs, code sets, or instruction sets stored in the memory 2820 and by invoking data stored in the memory 2820. In some embodiments, the processor 2810 may be configured in at least one form of hardware of: a digital signal processing (DSP), a field-programmable gate array (FPGA), a programmable logic array (PLA). The processor 2810 may integrate one or a combination of: a central processing unit (CPU), a graphics processing unit (GPU), and a modem. The CPU substantially processes an operating system, user interfaces and applications. The GPU may substantially be configured to render and draw displaying contents. The modem may be configured to process wireless communication. It is to be understood that the above modem may not be integrated into the processor 2810, and may be configured as an independent communication chip alone.

The memory 2820 may include a Random Access Memory (RAM) or a read-only memory (ROM). The memory 2820 may be used to store instructions, programs, codes, code sets, or instruction sets. For example, an apparatus may be stored in the memory 2820. The memory 2820 may include a storage program area and a storage data area. The storage program area may store instructions for implementing the operating system, instructions for implementing at least one function (such as a touch function, a sound playing function, an image displaying function, and so on), instructions for implementing each of the method embodiments described below.

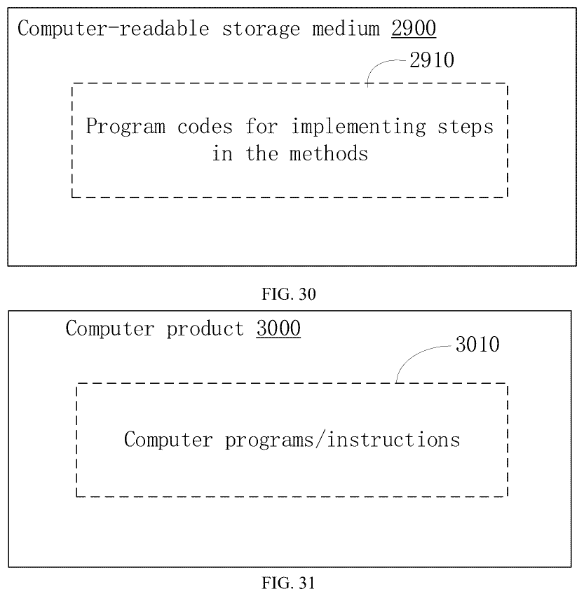

As shown in FIG. 30, FIG. 30 is a structural schematic diagram of a computer-readable storage medium according to an embodiment of the present disclosure. The computer-readable storage medium 2900 may have program codes stored therein, the program codes may be invoked by a processor to execute the method described in the above method embodiment.

The computer-readable storage medium 2900 may be an electronic memory such as a flash memory, an electrically erasable programmable read-only memory (EEPROM), an EPROM, a hard disk, or a ROM. In some embodiments, the computer-readable storage medium 1100 may include a non-volatile computer-readable medium. The computer-readable storage medium 2900 may have a storage space for program codes 2910 that perform any of the steps in the method described above. The program codes may be read from or written to one or more computer program products. The program codes 2910 may, for example, be compressed in an appropriate form.

As shown in FIG. 31, FIG. 31 is a structural schematic diagram of a computer product 3000 according to an embodiment of the present disclosure. The computer program product may include a computer program/instruction 3010 which may implement the method described above when executed by a processor.

Finally, it should be noted that the above embodiments are only described to illustrate technical solutions of the present disclosure, but not to limit the technical solutions. Although the present disclosure is described in detail based on the foregoing embodiments, any ordinary skilled person in the art shall understand that the technical solutions as recorded in the above embodiments may be modified, or equivalent replacements may be made for some of the technical features. The modifications or replacements do not cause corresponding technical solutions to depart from the essence of the technical solutions of the present disclosure.

What is claimed is:

1. An image processing method, performed by an electronic device, the method comprising:
receiving a first preset operation configured to mark at least one of a plurality of video frames in a case that the plurality of video frames are displayed on a screen of the electronic device;
after receiving the first preset operation, determining a target video frame corresponding to the first preset operation;
setting a specified mark for the target video frame.

2. The image processing method according to claim 1, wherein the setting a specified mark for the target video frame comprises:
determining a timestamp of the target video frame corresponding to the specified mark;
determining a target position corresponding to the timestamp on a first progress bar corresponding to the plurality of video frames;
during the plurality of video frames being displayed on the screen, displaying the first progress bar on the screen; and correspondingly displaying the specified mark at the target position on the first progress bar.

3. The image processing method according to claim 1, wherein displaying the plurality of video frames on the screen of the electronic device comprises recording a video on the electronic device;
after the setting a specified mark for the target video frame, the method further comprises:
saving the plurality of video frames as a video file, marking the target video frame in the video file with the specified mark.

4. The image processing method according to claim 3, wherein after the setting a specified mark for the target video frame, the method further comprises:
during the video file being edited, displaying a second progress bar in a video editing interface;
and displaying the specified mark for the target video frame at the target position corresponding to the target video frame on the second progress bar;
detecting a touch operation performed on the specified mark, displaying a preset selection box at the target position corresponding to the specified mark on the second progress bar;
determining a region range boxed by a user based on the preset selection box on the second progress bar; and
taking all video frames corresponding to the region range on the second progress bar as a video segment corresponding to the specified mark.

5. The image processing method according to claim 4, wherein the preset selection box comprises a first box and a second box, the determining a region range boxed by a user based on the preset selection box on the second progress bar comprises:
changing a position of a specified box on the second progress bar based on a detected sliding operation performed on the specified box, wherein the specified box is at least one of the first box and the second box; and
when the sliding operation is completed, taking a region between the first box and the second box as the boxed region range.

6. The image processing method according to claim 5, further comprising:
determining a specified position of the specified box on the second progress bar between a touch start time point of the sliding operation and a touch end time point of the sliding operation;
displaying, in the video editing interface, a video frame corresponding to the specified position on the second progress bar.

7. The image processing method according to claim 6, wherein the first box and the second box are respectively located on a left side and a right side of a centerline region of a preset box, the centerline region is located at the target position of the second progress bar; the specified box is the first box, and the displaying, in the video editing interface, a video frame corresponding to the specified position on the second progress bar, comprises:
displaying, in a first region of the video editing interface, the video frame corresponding to the specified position of the first box on the second progress bar; displaying the target video frame in a second region of the video editing interface, wherein the first region is located closer to a start position of the second progress bar than the second region is.

8. The image processing method according to claim 6, wherein the first box and the second box are respectively located on a left side and a right side of a centerline region of a preset box, the centerline region is located at the target position of the second progress bar; the specified box is the second box, and the displaying, in the video editing interface, a video frame corresponding to the specified position on the second progress bar, comprises:
displaying the target video frame in a first region of the video editing interface; and displaying, in a second region of the video editing interface, the video frame corresponding to the specified position of the second box on the second progress bar; wherein the first region is located closer to a start position of the second progress bar than the second region is.

9. The image processing method according to claim 3, wherein after the saving the plurality of video frames as a video file, the method further comprises:
during editing the video file, displaying a second progress bar in a video editing interface, displaying the specified mark for the target video frame at the target position corresponding to the target video frame on the second progress bar;
detecting a dragging operation performed on the specified mark;
determining, based on the dragging operation, an end position corresponding to the specified mark on the second progress bar when the dragging operation is completed;
taking a video frame corresponding to the end position as the video frame corresponding to the specified mark.

10. The image processing method according to claim 3, wherein after the saving the plurality of video frames as a video file, the method further comprises:
during editing the video file, displaying a second progress bar in the video editing interface, and displaying the specified mark for the target video frame at the target position corresponding to the target video frame on the second progress bar;
detecting a dragging operation performed on the specified mark; and changing, based on the dragging operation, a position of the video frame corresponding to the specified mark on the second progress bar.

11. The image processing method according to claim 1, wherein the receiving a first preset operation configured to mark at least one of a plurality of video frames, in a case that the plurality of video frames are displayed on a screen of the electronic device, comprises:
during a video recording operation of the electronic device being performed, displaying a plurality of video frames captured during a video recording process on the screen of the electronic device; and receiving the first preset operation configured to mark at least one of the plurality of video frames.

12. An image processing method, performed by an electronic device, the method comprising:
displaying, in a specified interface, a preset progress bar corresponding to a video file; displaying, at a target position corresponding to the target video frame on the preset progress bar, a specified mark of a target video frame, wherein the specified mark is a marker set for the target video frame based on a first preset operation when a plurality of video frames are displayed on a screen of the electronic device;
performing, based on a first target operation performed on the specified mark, a second target operation corresponding to the first target operation on a video frame corresponding to the specified mark.

13. The image processing method according to claim 12, wherein the specified interface comprises a video editing interface, the preset progress bar comprises a second progress bar; and the performing, based on a first target operation performed on the specified mark, a second target operation corresponding to the first target operation on a video frame corresponding to the specified mark comprises:
performing, based on the second preset operation performed on the specified mark, an editing operation corresponding to the second preset operation on the video frame corresponding to the specified mark.

14. The image processing method according to claim 13, wherein the performing, based on the second preset operation performed on the specified mark, an editing operation corresponding to the second preset operation on the video frame corresponding to the specified mark, comprises:
detecting a touch operation performed on the specified mark, displaying a preset selection box at a target position corresponding to the specified mark on the second progress bar;
determining a region range boxed by a user based on the preset selection box on the second progress bar;
taking all video frames corresponding to the region range on the second progress bar as a video segment corresponding to the specified mark.

15. The image processing method according to claim 13, wherein the performing, based on the second preset operation performed on the specified mark, an editing operation corresponding to the second preset operation on the video frame corresponding to the specified mark, comprises:
determining, based on a dragging operation performed on the specified mark, an end position corresponding to the specified mark on the second progress bar when the dragging operation is completed; and
taking a video frame corresponding to the end position as the video frame corresponding to the specified mark.

16. The image processing method according to claim 13, wherein the performing, based on the second preset operation performed on the specified mark, an editing operation corresponding to the second preset operation on the video frame corresponding to the specified mark, comprises:
changing, based on a dragging operation performed on the specified mark, a position of the video frame corresponding to the specified mark on the second progress bar.

17. The image processing method according to claim 13, wherein a plurality of specified marks are set; and after the performing, based on the second preset operation performed on the specified mark, an editing operation corresponding to the second preset operation on the video frame corresponding to the specified mark, the method further comprises:
combining and saving all video frames corresponding to all the plurality of specified marks as a first video file.

18. The image processing method according to claim 13, wherein after the performing, based on the second preset operation performed on the specified mark, an editing operation corresponding to the second preset operation on the video frame corresponding to the specified mark, the method further comprises:
saving video frames corresponding to each specified mark as a video file.

19. The image processing method according to claim 13, wherein after the performing, based on the second preset operation performed on the specified mark, an editing operation corresponding to the second preset operation on the video frame corresponding to the specified mark, the method further comprises:
when one video frame corresponds to the specified mark, saving the video frame corresponding to the specified mark as a target image.

20. An electronic device, comprising:
one or more processors;
a memory; and
one or more applications, being stored in the memory and configured to be executed by the one or more processors to perform operations of:
receiving a first preset operation configured to mark at least one of a plurality of video frames in a case that the plurality of video frames are displayed on a screen of the electronic device;
after receiving the first preset operation, determining a target video frame corresponding to the first preset operation;
setting a specified mark for the target video frame.
